(19) United States
(12) Patent Application Publication
(10) Pub. No.: US 2013/0223669 A1
(43) Pub. Date: Aug. 29, 2013

(54) HEADPHONES WITH A MODIFIABLE TIMBRE

(71) Applicant: Chin-Chun CHEN, Taipei City (TW)

(72) Inventor: Chin-Chun CHEN, Taipei City (TW)

(21) Appl. No.: 13/585,397

(22) Filed: Aug. 14, 2012

(30) Foreign Application Priority Data
Feb. 24, 2012 (TW) 101203449

(51) Int. Cl. H04R 1/10

(52) U.S. Cl. 381/370

(57) ABSTRACT

A pair of headphones includes a pair of earpiece units each including a base member, a plate member, and a rotary disk. The plate member includes a plate body having a center bore in which a speaker is disposed and a hole portion radially spaced apart from the center bore and covered by a damping member. The rotary disk is mounted between the plate and base members, and includes a disk body having a center hole registered with the center bore, and a through hole spaced apart from the center hole by a distance equal to a distance between the hole portion and the center bore. The rotary disk is rotatable between open and closed positions, where the hole portion is registered and misaligned with the through hole, respectively.

### CROSS-REFERENCE TO RELATED APPLICATION

This application claims priority of Taiwanese application no. 101203449, filed on Feb. 24, 2012.

### BACKGROUND OF THE INVENTION

1. Field of the Invention

This invention relates to a pair of headphones, more particularly to a pair of headphones with a modifiable timbre.

2. Description of the Related Art

A pair of headphones is an indispensible electronic device for private listening without disturbing other people and capable of insulating a listener from noise of surrounding environment. Taiwanese Utility Model No. M408207 discloses a pair of conventional headphones capable of improving frequency response effect thereof. The conventional headphones include two earpieces, each of which defines a sound chamber therein and comprises a speaker and a damper that is disposed between the speaker and the sound chamber. An acoustic wave outputted by the speaker propagates through the damper and resonates in the sound chamber such that a frequency response of the conventional headphones is changed. However, the damper of such headphones is usually irreplaceable and the frequency response of such headphones depends upon the size of the damper. Therefore, the conventional headphones cannot provide different sound effects (i.e., timbre of the headphones).

### SUMMARY OF THE INVENTION

Therefore, the object of the present invention is to provide a pair of headphones with a modifiable timbre.

Accordingly, the pair of headphones of the present invention includes a headband having opposite end portions and a pair of earpiece units respectively disposed at the end portions of the headband. Each of the earpiece units includes a base member, a plate member, at least one damping member a speaker, and a rotary disk. The base member includes a seat portion connected to a respective one of the end portions and a surrounding portion extending from a periphery of the seat portion away from the respective one of the end portions. The plate member is coupled to the surrounding portion of the base member, and includes a plate body formed with a center bore and at least one through hole portion radially and outwardly spaced apart from the center bore, and at least one pillar extending from the plate body toward the seat portion of the base member and radially and outwardly spaced apart from the center bore. The damping member covers the through hole portion in the plate body of the plate member. The speaker is disposed in the center bore in the plate body of the plate member. The rotary disk is mounted between the plate member and the surrounding portion along an axis, and includes a disk body formed with a center hole formed through the disk body and registered with the center bore in the plate body of the plate member along the axis, at least one guiding groove extending angularly about the axis, receiving and allowing the pillar of the plate body of the plate member to slide therein, and having opposite first and second ends, and at least one through hole radially spaced apart from the guiding groove, and spaced apart from the center hole by a distance equal to a distance between the through hole portion and the center bore in the plate body of the plate member. The rotary disk is rotatable with respect to the plate member about the axis between an open position, where the pillar of the plate member is proximate to the first end of the guiding groove and the through hole portion in the plate body of the plate member is registered with the through hole in the disk body of the rotary disk, and a closed position, where the pillar is proximate to the second end of the guiding groove and the through hole portion is misaligned with the through hole and is covered by the disk body of the rotary disk.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a preferred embodiment of a pair of headphones according to the present invention;

FIG. 2 is an exploded view of an earpiece unit of the preferred embodiment of the headphones;

FIG. 3 is a schematic side view of the earpiece unit of the preferred embodiment of the headphones for illustrating a rotary disk of the earpiece unit at an open position relative to a plate member of the earpiece unit;

FIG. 4 is a schematic side view similar to FIG. 3, where the rotary disk is disposed at an intermediate position relative to the plate member of the earpiece unit;

FIG. 5 is a schematic side view similar to FIG. 3, where the rotary disk is disposed at a closed position relative to the plate member of the earpiece unit; and

FIG. 6 is a plot illustrating frequency response of the headphones of the preferred embodiment when the rotary disk is at the open, intermediate and closed positions.

### DETAILED DESCRIPTION OF THE PREFERRED EMBODIMENT

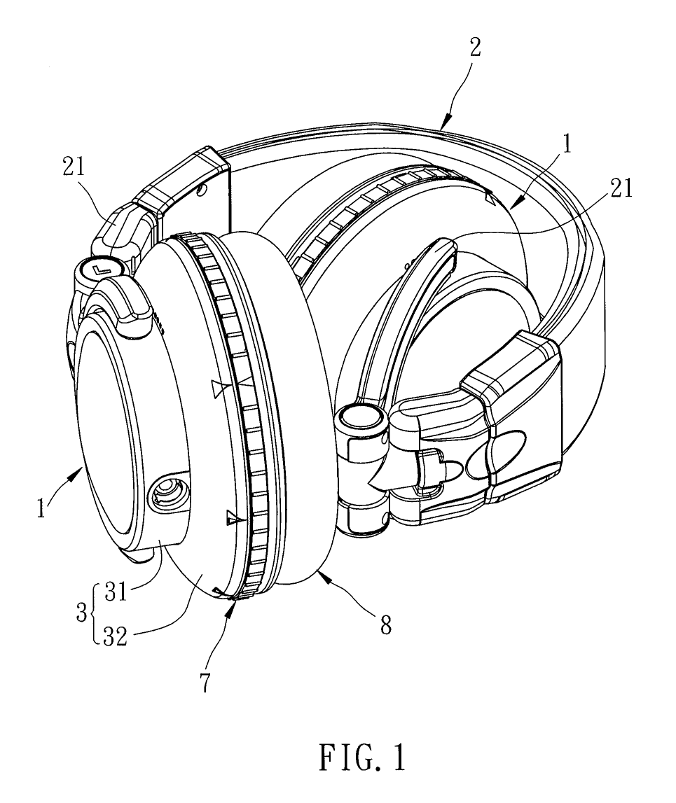

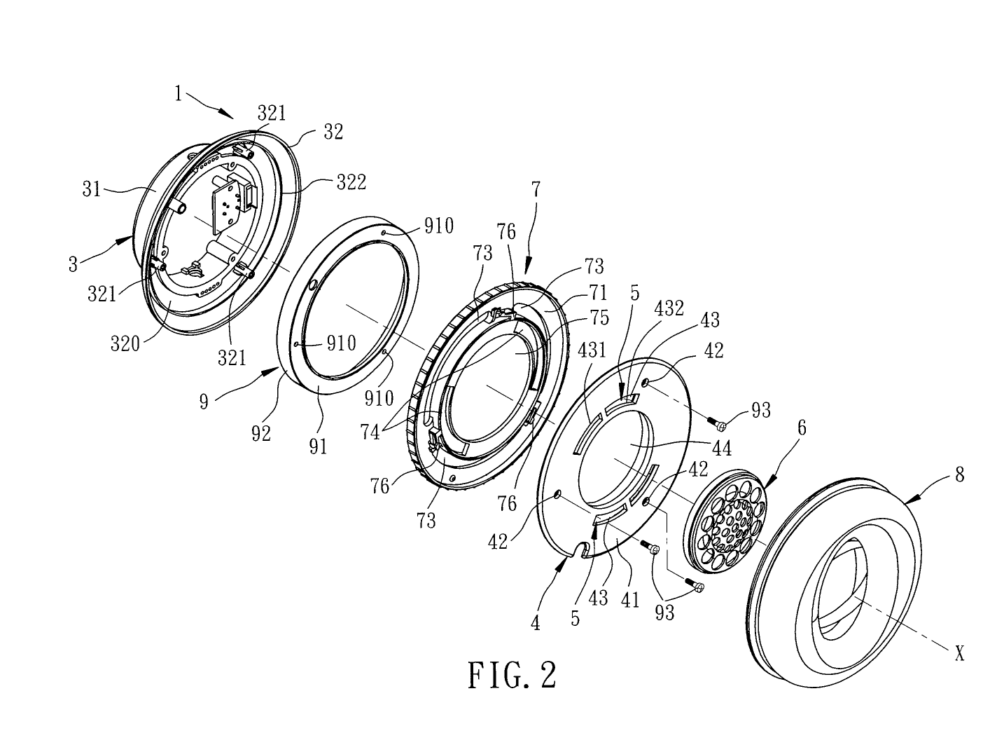

Referring to FIGS. 1 and 2, a preferred embodiment of a pair of headphones with a modifiable timbre according to the present invention is shown. The headphones includes a headband 2 having opposite end portions 21 and a pair of earpiece units 1 respectively disposed at the end portions 21 of the headband 2. Each of the earpiece units 1 includes a base member 3, a plate member 4, two damping members 5, a speaker 6, a rotary disk 7, an ear pad 8 and a frame 9. It is noted that since the configurations of the earpiece units 1 are identical, only one of the earpiece units 1 will be illustrated in the following description for the sake of brevity.

The base member 3 includes a seat portion 31 connected to a respective one of the end portions 21 of the headband 2, and a surrounding portion 32 extending toward the plate member 4 from a periphery of the seat portion 31 away from the respective one of the end portions 21. The surrounding portion 32 of the base member 3 has an abutting surface 320 facing the plate member 4, and includes three screw sockets 321 protruding from the abutting surface 320 toward the plate member 4 and a ring wall 322 extending from the abutting surface 320 toward the plate member 4 and surrounding the screw sockets 321.

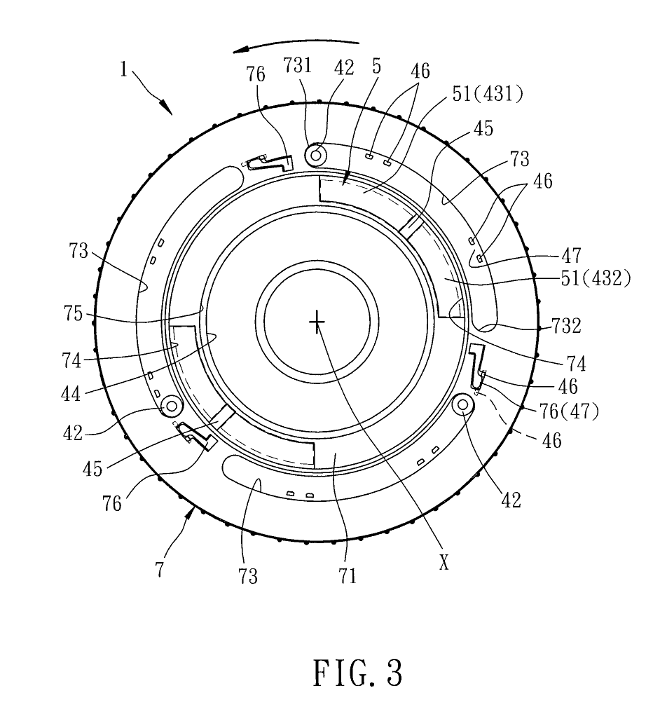

Further referring to FIGS. 3 to 5, the plate member 4 is coupled to the surrounding portion 32 of the base member 3, and includes a plate body 41, three pillars 42, two ribs 45 and nine pairs of protrusions 46. The plate body 41 is formed with a center bore 44 and two through hole portions 43 that are radially and outwardly spaced apart from the center bore 44 about an axis (X) and that are diametrically opposite to each other. The ribs 45 are disposed on the plate body 41 and extend radially, and each of the ribs 45 divides a respective one of the through hole portions 43 into first and second holes 431, 432. The pillars 42 are radially and outwardly spaced apart from the center bore 44, are equidistantly and angularly spaced apart from one another about the axis (X), are aligned respectively with the screw sockets 321 of the base member 3, and extend from the plate body 41 toward the seat portion 31 of the base member 3. The protrusions 46 extend from the plate body 41 toward the seat portion 31 of the base member 3, every three pairs of the protrusions 46 are equidistantly disposed between an adjacent pair of the pillars 42, and each pair of the protrusions 46 cooperatively define an engaging portion 47 therebetween. Namely, there are three engaging portions 47 disposed between an adjacent pair of the pillars 42. The speaker 6 is disposed in the center bore 44 in the plate body 41 of the plate member 4.

Each of the damping member 5 includes two pads 51 angularly spaced apart from each other and respectively covering the first and second holes 431, 432 of a respective one of the through hole portions 43 in the plate body 41 of the plate member 4.

The rotary disk 7 is mounted between the plate member 4 and the surrounding portion 32 of the base member 3 along the axis (X), and includes a disk body 71 and three resilient hooks 76. The disk body 71 is formed with a center hole 75, three guiding grooves 73 and two through holes 74. The center hole 75 is formed through the disk body 71 and is registered with the center bore 44 in the plate body 41 of the plate member 4 along the axis (X). The guiding grooves 73 are equidistantly and angularly spaced apart from one another, extend angularly about the axis (X), and receive and allow the pillars 42 of the plate body 41 of the plate member 4 to slide therein, respectively. Each of the guiding grooves 73 has opposite first and second ends 731, 732. The through holes 74 extend angularly about the axis (X), are equidistantly and angularly spaced apart from each other, are radially spaced apart from the guiding grooves 73, and are radially spaced apart from the center hole 75 by a distance equal to a distance between the through hole portions 43 and the center bore 44 in the plate body 41.

The resilient hooks 76 of the rotary disk 7 protrude from the disk body 71 toward the plate member 4, and each of the resilient hooks 76 is disposed between an adjacent pair of the guiding grooves 73. The ear pad 8 covers the plate member 4 and is opposite to the rotary disk 7 along the axis (X).

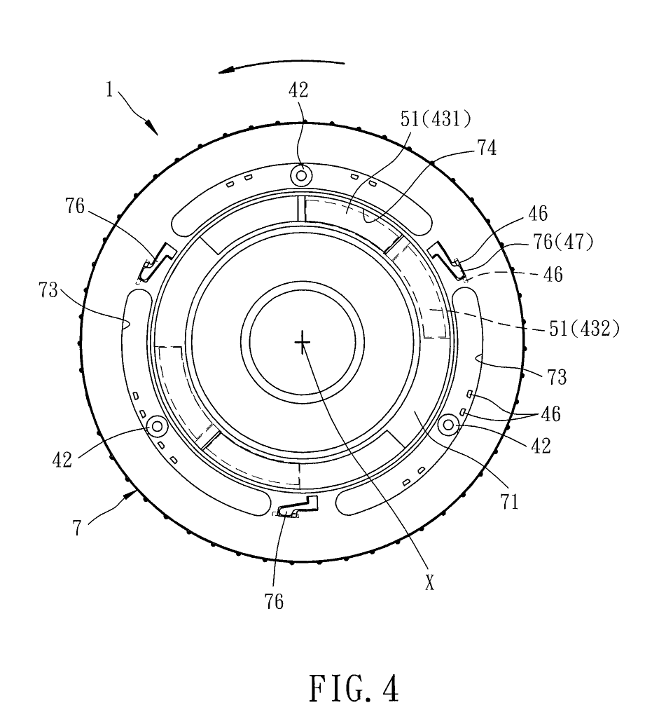

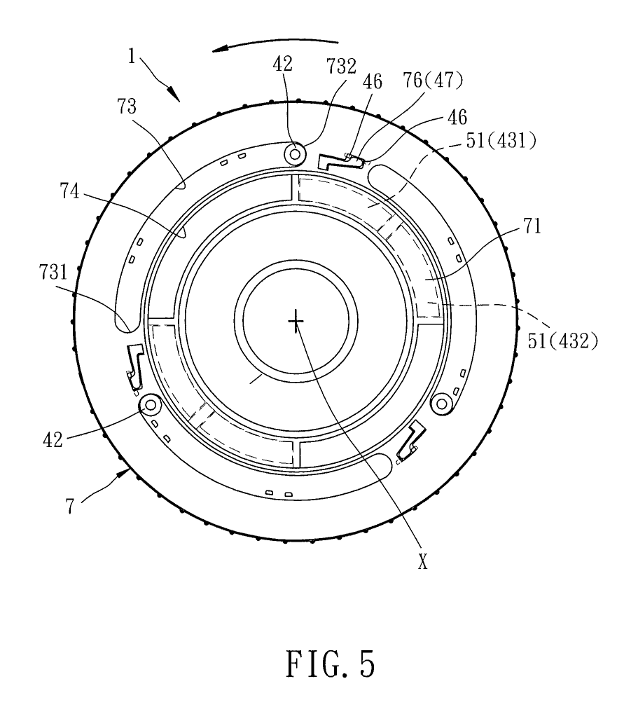

The rotary disk 7 is rotatable with respect to the plate member 4 about the axis (X) among an open position (see FIG. 3), an intermediate position (see FIG. 4), and a closed position (see FIG. 5). Each of the resilient hooks 76 engages a particular one of the three engaging portions 47 between an adjacent pair of the pillars 42 when the rotary disk 7 is at one of the open, intermediate and closed positions.

As shown in FIG. 3, at the open position, each of the pillars 42 of the plate member 4 is proximate to and abuts against the first end 731 of a respective one of the guiding grooves 73, and the through hole portions 43 in the plate body 41 of the plate member 4 are respectively registered with the through holes 74 in the disk body 71 of the rotary disk 7. Referring to FIG. 4, at the intermediate position, the first hole 431 of each through hole portion 43 in the plate body 41 of the plate member 4 is registered with a respective one of the through holes 74 while the second hole 432 of the through hole portion 43 is misaligned with the respective one of the through holes 74. Referring to FIG. 5, at the closed position, each of the pillars 42 is proximate to and abuts against the second end 732 of the respective one of the guiding grooves 73, and the through hole portions 43 are misaligned with the through holes 74 and are covered by the disk body 71 of the rotary disk 7.

Additionally, the frame 9 is disposed between the base member 3 and the rotary disk 7 and includes an annular plate 91 and an annular wall 92. The annular plate 91 is formed with three through holes 910 registered respectively with the screw sockets 321 of the base member 3. The annular wall 92 extends from a periphery of the annular plate 91 toward the base member 3 and has a rim abutting against the abutting surface 320 of the base member 3.

Each of the earpiece units 1 further includes three screws 93 respectively extending through the pillars 42 of the plate member 4 and the through holes 910 in the frame 9, and threadedly and respectively engaging the screw sockets 321. Hence, a sound chamber is defined in the earpiece unit 1. It is noted that a space defined between the abutting surface 320 of the base member 3 and the frame 9 is a rear chamber of the sound chamber.

By virtue of the rotary disk 7, frequency response of the earpiece unit 1 can be changed with three stages since configuration of the sound chamber in the earpiece unit 1 is varied according to the position of the rotary disk 7 relative to the plate member 4. Namely, the amount of acoustic wave generated by the speaker 6 propagating through the damping members 5 varies among in the open, intermediate and closed positions.

Accordingly, an amplitude, a waveform and a resonant frequency of the acoustic wave generated by the speaker 6 are changed, and thus timbre of the headphones can be modified as desired.

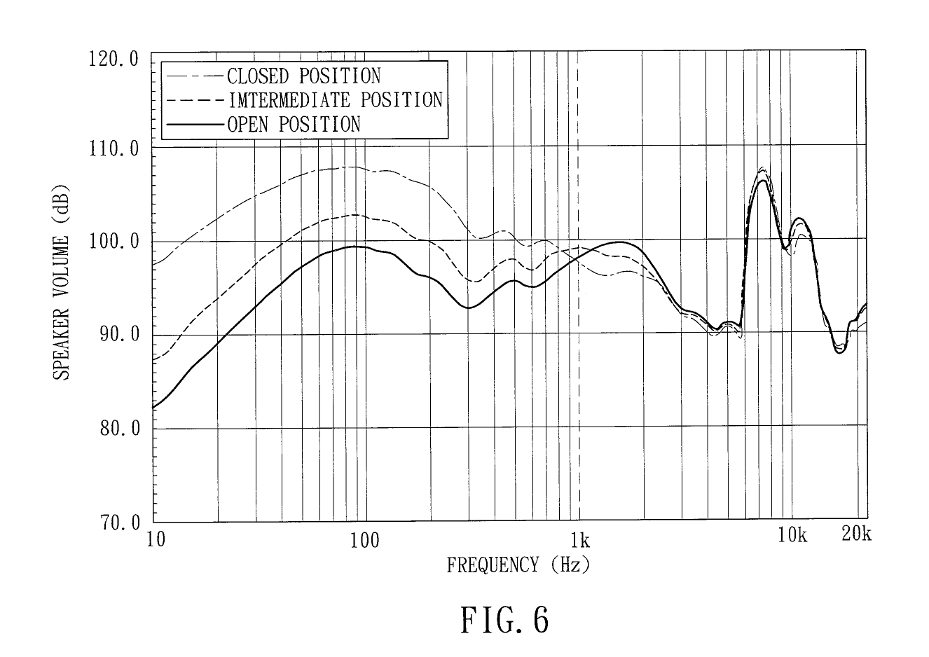

Referring to FIG. 6, which is a plot illustrating speaker volume relative to frequency of the acoustic wave outputted by the headphones of the preferred embodiment when the rotary disk 7 is at the open, intermediate and closed positions, amplitude of speaker volume at low frequency bandwidth (e.g., ranging from 10 Hz to 1 KHz) increases gradually when the rotary disk 7 is rotated from the open position to the closed position. It is evident that the frequency spectrum of the acoustic wave outputted by the earpiece unit 1 can be changed according to the position of the rotary disk 7 relative to the plate member 4. Therefore, users may adjust low frequency bandwidth, i.e., bass, of the acoustic wave outputted by the headphones of the present invention by simply rotating the rotary disk 7 as desired.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A pair of headphones with a modifiable timbre, said headphones comprising:
a headband having opposite end portions; and
a pair of earpiece units respectively disposed at said end portions of said headband, each of said earpiece units including:
a base member including a seat portion connected to a respective one of said end portions and a surrounding portion extending from a periphery of said seat portion away from the respective one of said end portions;
a plate member coupled to said surrounding portion of said base member, and including
a plate body formed with a center bore and at least one through hole portion radially and outwardly spaced apart from said center bore, and
at least one pillar extending from said plate body toward said seat portion of said base member and radially and outwardly spaced apart from said center bore;
at least one damping member covering said through hole portion in said plate body of said plate member; and
a speaker disposed in said center bore in said plate body of said plate member; and
a rotary disk mounted between said plate member and said surrounding portion along an axis, and including a disk body formed with
a center hole formed through said disk body and registered with said center bore in said plate body of said plate member along the axis,
at least one guiding groove extending angularly about the axis, receiving and allowing said pillar of said plate body of said plate member to slide therein, and having opposite first and second ends, and
at least one through hole radially spaced apart from said guiding groove, and spaced apart from said center hole by a distance equal to a distance between said through hole portion and said center bore in said plate body of said plate member;
said rotary disk being rotatable with respect to said plate member about the axis between an open position, where said pillar of said plate member is proximate to said first end of said guiding groove and said through hole portion in said plate body of said plate member is registered with said through hole in said disk body of said rotary disk, and a closed position, where said pillar is proximate to said second end of said guiding groove and said through hole portion is misaligned with said through hole and is covered by said disk body of said rotary disk.

2. The pair of headphones as claimed in claim 1, wherein:
said plate member includes three of said pillars equidistantly and angularly spaced apart from one another and two of said through hole portions diametrically opposite to each other;
each of said earpiece units includes two of said damping members respectively covering said through hole portions; and
said rotary disk includes three of said guiding grooves that are equidistantly and angularly spaced apart from one another, and two of said through holes that are diametrically opposite to each other.

3. The pair of headphones as claimed in claim 2, wherein:
said plate member further includes
two ribs which are disposed on said plate body, which extend radially, and each of which divides a respective one of said through hole portions into first and second holes, and
nine pairs of protrusions which extend from said plate body toward said rotary disk, every three pairs of which are equidistantly disposed between an adjacent pair of said pillars, and each pair of which cooperatively define an engaging portion therebetween;
said rotary disk further includes three resilient hooks which protrude from said disk body toward said plate member, each of which is disposed between an adjacent pair of said guiding grooves, and each of which engages said engaging portion between one of respective three pairs of said protrusions between an adjacent pair of said pillars; and
each of said damping members includes two pads angularly spaced apart from each other and respectively covering said first and second holes of a respective one of said through hole portions.

4. The pair of headphones as claimed in claim 3, wherein:
said surrounding portion of said base member of each of said earpiece units has an abutting surface facing said plate member, and includes three screw sockets that protrude from said abutting surface toward said plate member and that are aligned with said pillars of said plate member, and a ring wall extending from said abutting surface toward said plate member and surrounding said screw sockets;
each of said earpiece units further includes
a frame disposed between said base member and said rotary disk and including an annular plate that is formed with three through holes registered respectively with said screw sockets and an annular wall that extends from a periphery of said annular plate toward said base member and that has a rim abutting against said abutting surface of said base member, and
three screws respectively extending through said pillars of said plate member and said through holes in said frame, and threadedly engaging said screw sockets.

5. The pair of headphones as claimed in claim 1, wherein each of said earpiece units further includes an ear pad covering said plate member opposite to said rotary disk along the axis.
